(19) United States
(12) Patent Application Publication
(10) Pub. No.: US 2015/0148967 A1
(43) Pub. Date: May 28, 2015

(54) Methods, Systems, Apparatus and Software for Controlling Local Interior Environments

(71) Applicant: Twin Harbor Labs, LLC, Plano, TX (US)

(72) Inventors: James D Logan, Candia, NH (US); Blake Van Thof, Merrimac, MA (US); Kevin Castonguay, Weare, NH (US)

(73) Assignee: TWIN HARBOR LABS, LLC, Plano, TX (US)

(21) Appl. No.: 14/514,915

(22) Filed: Oct. 15, 2014

Related U.S. Application Data
(60) Provisional application No. 61/902,202, filed on Nov. 9, 2013.

(51) Int. Cl. F24F 11/00; G06F 1/26; G05B 15/02

(52) U.S. Cl. CPC F24F 11/0009; G05B 15/02; G06F 1/26
USPC 700/276

(57) ABSTRACT

Methods, systems, apparatus and software for controlling environmental conditions of an interior location, such as a room or office, are provided. In one aspect, the invention provides a computer-controlled system for determining an improved energy configuration for a structure. In some embodiments, the invention includes: an electronic memory storage device configured to store electronically encoded signals corresponding to at least one location parameter of the structure; an electronic memory storage device configured to store electronically encoded signals corresponding to at least one construction parameter of the structure; an electronic memory storage device configured to store electronically encoded signals corresponding to at least one atmospheric parameter of the structure. The invention also includes at least one electronic computer instruction processor configured to execute electronically encoded instructions to determine at least one recommendation for an improved energy configuration for the structure based at least in part on the above-mentioned parameters.

### 1 CROSS-REFERENCE TO RELATED APPLICATIONS

This application claims priority under 35 U.S.C. §119(e) to provisional U.S. Patent Application Ser. No. 61/902,202 filed 9 Nov. 2013, the entire disclosure of which is incorporated herein by reference in its entirety and for all purposes.

### 2 NOTICE OF COPYRIGHT

Portions of this patent application include materials that are subject to copyright protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials. Copyright © 2014 Twin Harbor Labs. All Rights Reserved.

### 3 BACKGROUND OF THE INVENTION

3.1 Field of the Invention

The present invention provides systems, apparatus, software, and methods for monitoring and controlling local interior environments, especially living spaces. More specifically, the present invention provides systems, apparatus, software, and methods for improving and maximizing the efficient use of energy for heating and cooling living spaces, such as homes and apartments, including easy to use environmental and energy monitors and software. The present invention has applications in the fields of energy conservation, architecture, software, and environmental sensors.

3.2 The Related Art

Energy costs for heating and cooling have begun rising after several decades of relative stability and even decline. Coupled with the weak economic performance of the last several years, the proportion of household incomes and office budgets devoted to heating and cooling has shifted dramatically. For example, the price of a barrel of oil jumped from around $18 in November of 2001 to a high of about $145 in July of 2008, and currently is about $100. U.S. electricity costs (kilowatt-hours) jumped from about 11 cents in September 2001 to about 16 cents currently.

Not surprisingly then, many individuals and business owners are looking to reduce their energy costs by finding more efficient ways to heat and cool their living and working spaces. Retrofitting existing spaces to use energy more efficiently, e.g., by adding or replacing insulation, installing more efficient windows, and installing lighting timers and programmable thermostats, can be very useful; but these steps often require large initial costs for materials and installation, and so take time before cost savings can be realized. Increasing the efficient use of energy using the existing structural features and controls, however, can deliver results immediately. The problem, however, is determining the existing sources of inefficiency and the parameters that can be optimized to improve efficiency; often such determinations require costly “energy audits” that can only consider a single point in time rather than the environmental changes that occur as the seasons change, and often ignore the individual preferences and needs of those who actually use the space.

For example, in order to make an accurate assessment on whether to open windows to save money, one would have to predict weather patterns, log and predict temperature and humidity, then figure out what works best. If they happen to figure out what actually does work best, they will have to continuously implement these actions of investigating day in and day out which would be extremely time consuming to the point at which the pros. would fall short of the cons. They may also wonder when the best time would be to cool or heat their homes: in the morning, before work, or before they go to sleep. Should they open the windows on a hot day if the breeze is coming through to cool their home and save energy? If a person is trying to cool their home while saving money, should they open windows at night and shut them in the morning? Should they close the shades when the sun comes across the windows? Or should they just close everything up and turn the air conditioning unit on? Its never known for sure what the best option is, the occupant can only know how the climate in their house reacts to these actions. Even then, there would be a lot of guessing and predictions involved. So much guessing is involved that that the only logical solution for most homeowners would likely be to keep all the windows shut and leave the HVAC unit running.

Over the past decade, a large segment of the population has come to use and even rely on applications running on highly portable computing devices, such as personal data assistants (“PDAs”), so-called “smartphones”, and tablet computers. Because such devices can be carried easily, they have become almost indispensable for individuals who need to monitor health problems, such as medication schedules and glucose monitoring, or want instant access to useful information such as calorie counts or sugar content for foods. Increasingly, such devices are connected to other devices and sensors (such as the Global Positioning System, “GPS”) to provide more information about the surroundings of the user. In some cases, such devices are even used to control lighting and heating remotely, e.g., over an Internet connection.

However, present devices have no capability of considering or optimizing the energy efficiency of an interior location, especially for older, “dumb” structures that lack sophisticated ultra-modern sensors and displays such as those envisaged by Steven S. Intille in “Designing a home of the future”, Pervasive Computing, 76-82 (April-June 2002). Although the questions posed and actions taken seem almost trivial, reasonable answers based on even simpler realistic modeling require very intensive computer operations. And repeating such operations at various times of the day, or in response to changes in the actual or forecast weather conditions, make obtaining such reasonable answers impossible for the average person.

It would be highly advantageous for individuals to understand the sources of energy efficiency in an interior location, and obtain information and advice on how to reduce the inefficiencies of that location without resorting to expensive retrofitting or installing new systems. Moreover, it would be better still if such information and advice reflected the personal needs and preferences of those in the location at all times. The present invention meets these and other needs.

### 4 SUMMARY OF EMBODIMENTS OF THE INVENTION

The present invention provides methods, apparatus, systems, and software for enhancing the energy efficiency and user comfort of a location, particularly an interior location such as a room or office.

In one aspect, the present invention provides systems for determining improved energy configurations of a structure and the user of such a structure. In a first embodiment, the present invention provides an electronic, computer-controlled system for determining an improved energy configuration for a structure and user of such structure. In more particular embodiments, systems provided by the invention include: at least one electronic memory storage device having at least a portion thereof dimensioned and configured to accept and store electronically encoded signals corresponding to at least one location parameter of the structure; at least one electronic memory storage device having at least a portion thereof dimensioned and configured to accept and store electronically encoded signals corresponding to at least one construction parameter of the structure; and at least one electronic memory storage device having at least a portion thereof dimensioned and configured to accept and store electronically encoded signals corresponding to at least one atmospheric parameter of the structure. The systems further include at least one electronic computer instruction processor configured to execute electronically encoded instructions to determine at least one recommendation for an improved energy configuration for the structure. The computer instructions processor is configured to retrieve the encoded signals corresponding to the parameters.

More specific embodiments of the first embodiment include those for which the location parameter includes the geographical coordinates of the structure. Still more specifically, the parameter includes the compass facing of the structure. In other more specific embodiments of the system, the construction parameter includes at least one structure construction materials parameter. In still other more specific embodiments, the construction parameter includes at least one structure design parameter, which, in some still more specific embodiments, includes at least one parameter selected from the group consisting of: door location, door dimension, door type, window location, window dimension, and window type.

In other more specific embodiments of the first embodiment, the atmospheric parameter includes at least one atmospheric parameter related to the exterior of the structure. In still more specific embodiments thereof, the atmospheric parameter related to the exterior of the structure includes at least one parameter related to current weather condition proximate to the structure, the climate of the location of the structure, historical weather, climate information related to the location of the structure, and combinations thereof. In other more specific embodiments thereof, the atmospheric parameter related to the exterior of the structure includes at least one parameter related to vegetation proximate to the structure. In still more specific embodiments, the atmospheric parameter includes at least one atmospheric parameter related to the interior of the structure; and, in yet more specific embodiments, the atmospheric parameter related to the interior of the structure includes at least one parameter related to the internal temperature of the structure, the humidity of the structure, the comfort index of the structure, and combinations thereof.

In a second aspect, the present invention provides a method for determining an improved energy configuration for a structure and user of such structure. In first embodiment, a method of the invention includes: providing at least one electronic memory storage device having at least a portion thereof dimensioned and configured to accept and store electronically encoded signals corresponding to at least one location parameter of the structure; providing at least one electronic memory storage device having at least a portion thereof dimensioned and configured to accept and store electronically encoded signals corresponding to at least one construction parameter of the structure; providing at least one electronic memory storage device having at least a portion thereof dimensioned and configured to accept and store electronically encoded signals corresponding to at least one atmospheric parameter of the structure; providing at least one electronic computer instruction processor configured to execute electronically encoded instructions to determine at least one recommendation for an improved energy configuration for the structure, the computer instructions processor being further configured retrieve the encoded signals corresponding to the at least one location parameter, the at least one construction parameters, and the at least one atmospheric parameter. The electronically encoded instructions are executed using the electronic computer instruction processor.

In more specific embodiments of the first embodiment, the location parameter includes the geographical coordinates of the structure, and, still more specifically, the construction parameter includes at least one structure construction materials parameter. In other more specific embodiments, the construction parameter includes at least one structure design parameter.

In other more specific embodiments, of the first embodiment, the atmospheric parameter includes at least one atmospheric parameter related to the exterior of the structure, and still more specifically, the atmospheric parameter includes at least one atmospheric parameter related to the interior of the structure.

Still other more specific embodiments of the first embodiment further include providing a recommendation for an improved energy configuration for the structure to the user. Of these embodiments, still more specific embodiments further include providing at least one electronic memory storage device having at least a portion thereof dimensioned and configured to accept and store electronically encoded signals corresponding to at least one user action in response to the recommendation. Yet more specific embodiments still further include providing electronically encoded instructions to the at least one electronic computer instruction processor for determining patterns and trends of the user's responses to the recommendations and the user's actions to control the interior environment of the structure.

These and still other aspects and advantages of the present invention will become even more apparent when the following Detailed Description is read in conjunction with the accompanying Drawings.

### 5 BRIEF DESCRIPTION OF THE DRAWINGS

Exemplary embodiments of the present invention are described herein with reference to the following drawings.

FIG. 1 is a diagram illustrating an exemplary location for use in conjunction with the present invention.

FIG. 2 is a diagram illustrating exterior details of the exemplary location shown in FIG. 1.

FIG. 3 is a diagram illustrating interior details of the exemplary location shown in FIG. 1.

FIG. 4A and FIG. 4B are flowcharts illustrating an exemplary learning module in accordance with an embodiment of the present invention.

FIG. 5 is a graph showing suitable temperature and humidity parameters for indoor environmental quality according to ASHREA Standard 55-1992.

FIG. 6 is a diagram illustrating a theoretical model of the transmission of solar energy through a window.

### 6 DETAILED DESCRIPTION OF SOME EMBODIMENTS OF THE INVENTION

6.1 Overview

The present invention provides software, apparatus, methods, and systems for managing local interior environmental parameters, especially those parameters effective to control heating and cooling expenses. In addition to heating and cooling, the invention can be used to control other parameters such as humidity. As will be discussed herein, the invention provides software, methods, systems, and apparatus that calculate energy saving techniques, and send suggestions to the user, which the user can then implement either manually, automatically, or in some combination thereof. In some embodiments, the invention is implemented using so-called “smartphones” or “tablets” that allow convenience of use and portability for the user.

In some embodiments, the software is implemented on a smartphone; and the data the methods and software of the invention use are already available through currently embedded applications in the smartphone, or through off-site applications and processors such as partnering websites (or both). The data is retrieved from such locations, proximate sensors, user inputs, or any combination thereof, and then used according the methods described herein to recommend what actions should be taken by the user to optimize the user's local interior environmental conditions, including saving money by optimizing energy use (e.g., for heating and cooling). For example, in some embodiments the software of the invention will choose the most efficient actions for the user, and then send or otherwise communicate those suggestions to the user. The homeowner can then decide whether they would like to implement these money saving suggestions or not. In some embodiments, the invention suggests actions for the user to implement, such as opening or closing certain windows and shades. Other embodiments include sensing devices mounted on or proximate to one or more windows. Such devices determine when the window or the shade is opened or closed and also determine how much sunlight is entering the home at a giving time. Using such data, the invention can provide estimates of the savings possible by implementing the suggestions (or, conversely, the money spent by not implementing the suggestions).

6.2 Exemplary Data Used by the Invention to Make Recommendations

To further understand the invention, take a home in New England in winter time, on a sunny cold winter day, in a building or room with south facing windows, for example. After analyzing the various environmental parameters as illustrated herein, the invention suggests that the user opens the blinds during the day; this action can allow sun to heat the indoors instead of using heating fuel or electricity to run a furnace. Then, based on the inputs like building materials, blind types and colors, window types, door types, predictions of sunlight falling on the windows on that specific day, window size, etc., the invention will calculate the amount of money that can be saved during the day and relays this information to the user. For example, the algorithm predicts the user could save $1.20 if they open the shades that day. The user opens the shades after receiving the prediction. Based on actual sunlight exposure throughout the day (e.g., as determined by a light sensing device), which happened to be higher than what was predicted, the algorithm recalculates actual values of savings for this day and concludes that the savings were $1.45. Then the invention tells the user that they saved $1.45 that day by utilizing the suggested actions. The dollar amount of the savings can be saved into a database where the user could access it and look at their long-term savings as a weekly, monthly, or yearly breakdown.

### 6.2.1 Location

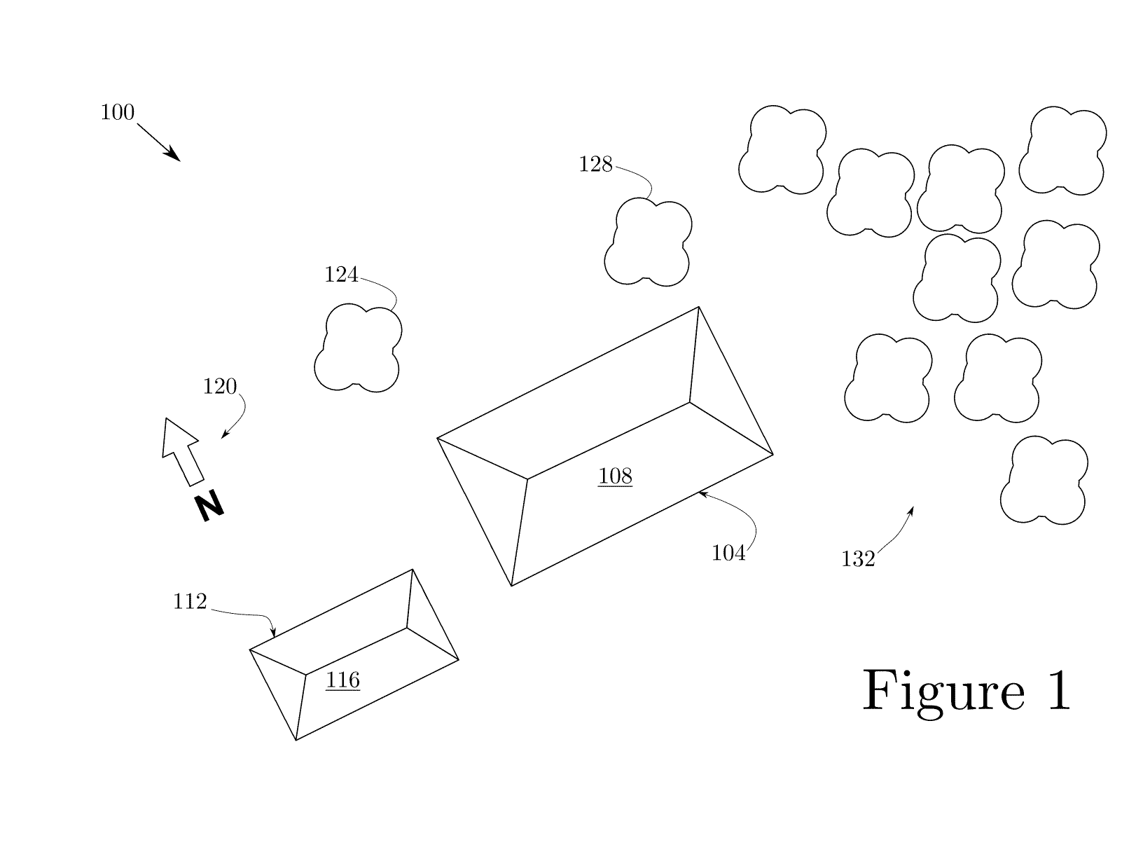

FIG. 1 illustrates a exemplary scenario including one or more structures and their exterior environment in accordance with the present invention (100). A structure (104) includes a roof or other exterior overhead covering (108, also referred to herein as a “roof”). The details of the structure and roof can vary quite widely without departing from the scope or spirit of the invention, including variation in size, shape, materials, geometry, color, venting, windows, and the like, as will be apparent to those having ordinary skill in the art. Adjacent structure 104 is a second structure (112) having an overhead covering (or roof, 116), the details of which, again, are widely variable without departing from the invention. Each structure is located at a specific geographical location and has a particular compass facing (120). Also proximate to structure 104 are trees 124 and 128, which may provide shade over covering 108 as well as acting as a wind barrier. The degree of protection from sun and win will depend on the species, age, and condition of the particular tree. In this particular example, a forest (132) is located near structure 104 to provide additional wind and possibly sun protection. The forest, however, is not likely to provide as much protection to structure 112. Each structure may, of course, provide some degree of wind and sun protection to the other. In some embodiments of the invention, such details are included in determining the recommendations provided by the invention.

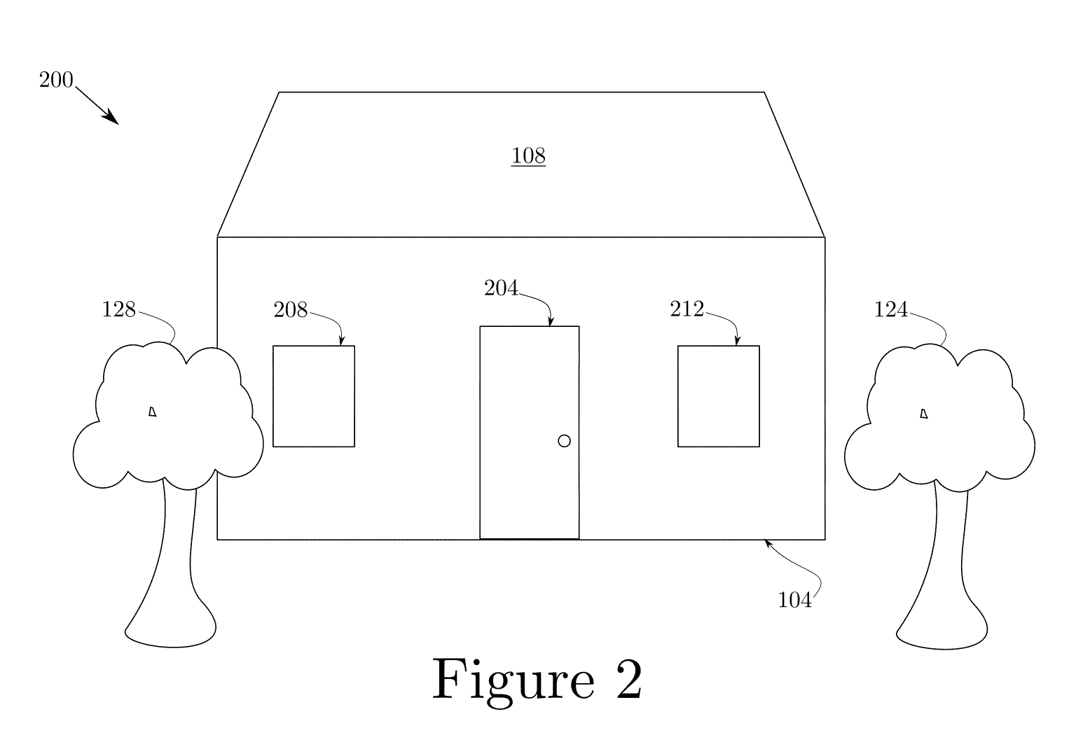

FIG. 2 illustrates the front of structure 104 at 200. The structure includes a door (204) and symmetrically arranged adjacent windows (208 and 212). As will be apparent to those having ordinary skill in the art, the interior environment of the structure will depend on the facing of its structure, since this will determining the amount and duration of sunlight and wind impinging on the windows, roof, and door. The amount of sunlight and wind can be moderated at least partly by proximate vegetation such as trees 124 and 128. In some embodiments of the invention, such details are included in determining the recommendations provided by the invention.

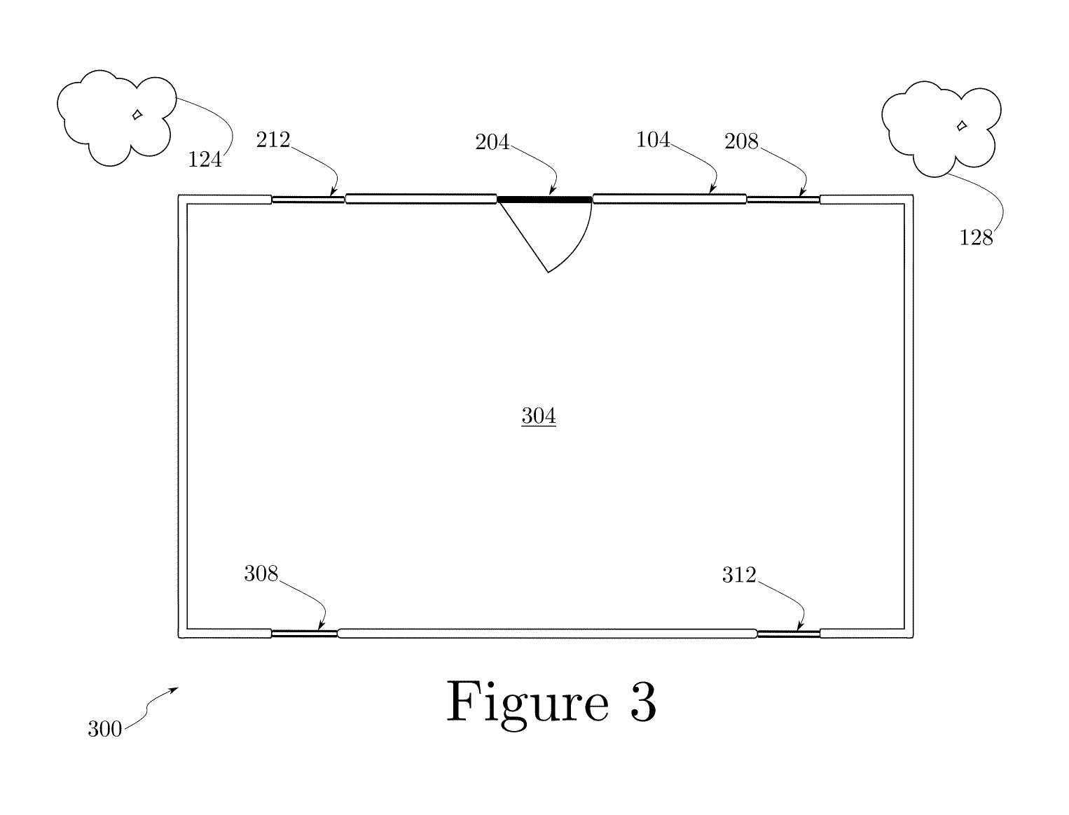

FIG. 3 illustrates the interior of structure 104 at 300. The interior of the structure (304) is shown as a single open space for illustrative simplicity, but can include additional subdivisions (i.e., rooms) as well as furniture, carpeting, drapes, lighting, appliances and electronics, and other accouterments associated with rooms, without departing from the scope or spirit of the invention as will be apparent to those having ordinary skill in the art. In some embodiments of the invention, such details are included in determining the recommendations provided by the invention.

The extension of the forgoing descriptions with respect to FIGS. 1-3 to commercial buildings, multi-story buildings, and various types of building construction (e.g., “super-insulated” structures) will be apparent to those having ordinary skill in the art. For example, many homes include an attic having particular insulation and ventilation factor that can be accommodated using the present invention by those having ordinary skill in the art.

In some embodiments, as illustrated below, the invention includes obtaining data from various sensor devices that are arranged and configured to monitor the condition of doors, windows, vents, and other relevant features of the structure. Such data can be relayed to an electronic computing device in accordance with the present invention, and more particularly as portable electronic computing device such as a smartphone, PDA, or even smart watch, using methods such as Bluetooth or similar device and protocols.

In some embodiments of the invention, a portable electronic computing device automatically interrogates one or more Bluetooth, or similarly enabled, sensors upon entering a room. In more specific embodiments, the device analyzes the data to determine if further action for recommending improving the energy efficiency or user comfort of the local interior environment is necessary.

In one embodiment the invention includes a device capable of receiving and processing cellular network location data, and will make suggestions based, at least in part, on input data from the user and sources that a cellular device already implements, e.g., hardware in the phone, for example the compass, sources from other application or the Internet, e.g., theweatherchannel.com, calendar information, Global Positioning Service (“GPS”), and government agencies such as the National Oceanic and Atmospheric Administration (“NOAA”). From these sources and other collected data, the invention accesses or derives relevant data for calculating advice and costs using data such as: GPS location of user, the current season, current and future outdoor temperature, the dew point, and the like. Such information can be used to determine such relevant exterior parameters as wind speed and direction, humidity, temperature, and the like.

In some embodiments, the user inputs information about the orientation of their home (walls and what direction they are facing). This information would be interpreted by the invention using the features already in most smartphones and tablets such as the accelerometer and compass. In other embodiments, photographic or video images are used to determine such orientation information, window size and transparency, and the like using image analysis.

In other embodiments, in addition to the above-described location and orientation data the user inputs data about the buildings surroundings, such as, but not limited to, forest, shrubbery or other buildings in the area, as these may cast a shadow on their house or the building, consequently affecting calculations. For example and not limitations, the user could give such input by doing something as simple as predicting how far away each tree is from the house, how tall it is, its species, how long the tree line is, and possibly other questions about orientation. Some embodiments include a visual display of the area to simplify the input or orientation of these shade producing objects around the house (see FIG. 1). For example when the user inputs data about the house the invention provides an overview of the house an orientation and size based upon inputs previously entered. Then the user could give an around about idea using a drawing input feature of the invention; from this the user could draw the trees and tree line, specify distance, height, and tree type. In some embodiments, the user estimates and draws into the invention such information, which is useful in determining orientation. As will be appreciated by those having ordinary skill in the art, such provisions ease the input of tree orientation form the users perspective. In still other embodiments, third party applications such as GOOGLE MAPS are used to determine building locations, orientations, etc.

In still other embodiments, noise conditions are also taken into account. In some embodiments, noise levels inside and outside of a structure are detected using a microphone, such as embedded with a smartphone or smart watch, and the estimated effects of ambient noise for the user from opening and closing windows and doors, or operating fans, are included in recommending action or estimating efficiency and comfort.

### 6.2.2 Home Construction

In some embodiments, the user inputs the number of windows on each wall of their home. The windows themselves each have different thermodynamic properties based on their properties such as, but not limited to, their size, pane type, insulation factor, and tint. In one embodiment, a simple way for the user to input this data is to select a type of window by showing them a model that is comparable to their window from a pre-loaded list; they can then select a window that best fits their homes windows and the app will use these window properties as inputs to accurately calculate numbers like thermal Resistance (“R value”).

In other embodiments, to achieve greater accuracy the user also inputs data based on the window coverings. The type of covering, e.g., blinds, drapes, shades, or otherwise, and the color of the covering, are relevant factors and are taken into consideration by the algorithm. Still other information that the user is prompted to input includes the square footage or cubic feet of the room or home. From the house or room area or volume, the volume of air is calculated; this may be calculated using the user's hardware or done manually with a physical measuring device and then inputted. In still other embodiments, the user is prompted to input information about energy cost, and heating and cooling unit type and efficiency. For example and without limitation, the user can either manually enter the cost using their energy bills, or they could choose their utility company and the invention will determine the cost from a list of average energy costs of the area in which the user resides.

In some embodiments, devices in accordance with the present invention communicate with, and control, automatic interior environment control systems, such as those in so-called “super-insulated” structures. In such embodiments, a device in accordance with the present invention may direct changes in air flow, heating, cooling, or other relevant variable to provide better comfort and efficiency.

### 6.2.3 HVAC System and Building Material

In still other embodiments, the user inputs additional information about their HVAC system, and the software is updated periodically to incorporate new technologies and types of HVAC units. For example and without limitation, the user could input the HVAC systems heating and cooling energy efficiency rating (“EER”). Another useful input is home construction material giving the algorithm useful information about insulating factor and thermal mass, material types include: brick, wood, cement, log homes, plastic siding, wood siding, etc., as all have different insulating properties and different thermal masses.

6.3 Determination of Recommendations

Once all the above-described data and the desired internal room temperature has been input, the invention determines the optimal state in which their windows and shades should be and communicates that state to the user; this will help to achieve maximum energy efficiency and optimal room temperature. In some embodiments, the user receives this information and is also told how much they can save if they utilize a specific energy saving method. Therefore, the cost they bear is the amount of money that could be saving if the user changes the state of their windows (e.g., whether and how much to open a window) and or window coverings (e.g., whether and how much to cover a window), giving them the ability to turn off their HVAC unit in specific instances.

In some embodiments, the invention relays at least two options for a window: open or closed. The invention will, in some embodiments, relay at least two options for the shades: open or closed. Based upon weather predictions as well as window and shade positing, the invention will also relay the days predicted savings in the morning (or whenever the user would like to view these predictions). Then the invention will recalculate these inputs using measured values taken throughout the day, such as, but not limited to: light captured, window position, and weather conditions. The invention will then update telling the user what they actually saved that day (rather than just a predicted number based upon weather forecast). In addition, the invention can be used to anticipate storms when the house is unoccupied.

For example and not limitation, when the user is about to leave for work in the morning, the invention determines whether it will be more energy efficient to leave the HVAC system on, or if it would be better to open the windows and shut the HVAC unit off. If the HVAC system is to be left on, should the user close the blinds in certain windows to save money? If the invention calculates a saving if the user opens the windows as well as the blinds, and shuts the HVAC system off, then it will relay this to the user as a predicted savings. For example, the invention's morning prediction may be that if the windows and blinds are opened through the day and the HVAC unit is shut off, the user could reap a savings of $2.10 for the day; then by the end of the day when the user returns and looks at his invention to see how much they actually saved they notice it says an actual saving of $1.90 that day. This is because the window sensor readings and actual weather was different than the predicted weather and sun light exposure values on this specific day.

In another example, the user utilizes the invention to solve a similar problem, one in which the invention determines if windows should be opened at night rather than running the HVAC unit, or if the user should use a fan instead of leaving the HVAC system on. In still other examples, the invention records the savings over a period of time to show the user that their actions are indeed saving them money by way of reduced energy consumption. In yet other embodiments, the invention gives a readout of actual savings and predicted savings for a day, week, month, year, or over the lifetime of the invention.

### 6.3.1 Input Methods

In various embodiments, the invention will use data from many different sources embedded in various hardware devices (e.g., smartphones and tablets), as well as sources from the Internet, and direct user input. The following is a brief summary of certain types of data.

### 6.3.1.1 User Data Input

Although typically the invention will access many data sources automatically (i.e., without direct user input), people have different comfort settings or preferences that are specific to the individual. (Examples of ranges of common user preferences for combinations of temperature and humidity are shown in FIG. 3.) In addition, as described above, certain initial parameters will also be entered manually, at least for the first determination. Such information includes, but is not limited to: the size (area) of the user's home, the user's desired interior temperature and dew point, relative humidity, the locations and facing directions of the windows, specifics about the home cooling and heating units, types of windows, presence and style and color of any window shades, the color of exterior siding, and type of insulation, are all possible inputs upon setup and may need to be revised later. An example of when these revisions may be necessary would be when the user buys a new air conditioner, or replaces any window or window treatment.

### 6.3.1.2 Weather

Weather, including various trends and patterns, and climate, are often the most important information in determining user recommendations. Data such as the hourly temperature, dew point, precipitation, humidity, wind speed and direction will often be relevant to determining the user's actions. For example, if a source predicts rain most of the day and have 80% to 90% relative humidity all day with a temperature of 81°, it is very unlikely that the user would want his (or her) windows open. The invention will determine such likely conclusions from the input information, and then tell the user to close the windows and keep their air conditioning on to keep their home cool and dry, or possibly to keep windows closed and AC off to save money while away from home. In the same situation, minus the rain and high humidity, the user may want his (or her) windows open throughout the day, e.g., if the breeze will be going through them creating a hot-air-out-cool-air-in cross wind. However, if there is a low wind speed that day, the invention will include such information and therefore may recommend the use of a fan to enhance air circulation for cooling. Thus the invention can assist the user in saving money while keeping the location within the acceptable temperature within the range set by the user.

### 6.3.1.3 Calendar

Some embodiments use the calendar that comes with the computer operating systems to determine the current season using the current date. In other embodiments the invention further combines location data (e.g., GPS data) to determine average temperature differences and a rate at which the seasonal temperature would change depending on location.

### 6.3.1.4 Location

Combined with the calendar as described above, location data is used in some embodiments to determine season and other useful information, such as exact location, in conjunction with data from other sources such as weather applications, mapping applications, to derive useful quantities, such as local altitude.

### 6.3.1.5 Compass

In some embodiments a compass is implemented, more specifically when the user is inputting the window locations, because the placement of windows in comparison to the direction of sun travel and wind direction is related to the temperature and humidity inside the house. For example, in New England, windows facing southeast and southwest will receive more sunlight than windows facing the other directions due to the nature of the suns path; thus, in cloudy weather the heating factor from sunlight will be lower than on a sunny day. In another example, if there was a significant breeze blowing from north to south, then the windows on the north and south walls would be affected, because a crosswind through the house could be established.

### 6.3.2 Method for Calculation

In some embodiments, factors such as compass heading, weather, GPS, and calendar data are accessed or prompted for in order to produce recommendations or actions for a user. Additional information is also obtained, e.g., through user queries including, but not limited to: the type of heating system (wood, gas, pellet, etc.), the type of cooling system, the size (area) of the location, the cost of utilities, and the desired interior temperature. If the desired indoor temp is unknown, then the system will default to a preset temperature. In some embodiments this is determined as shown below. Next compass and the user input are used to determine where the windows in the building are located. From this data, the direction the windows are facing is determined, which windows are exposed to sunlight, and how much sunlight is available depending on the time of year, among other calculations and determinations. This data, as well as the calendar and weather data, is then processed. In some embodiments, the recommendations are based on the assumption that if the chance of rain is low, then the dew point is low, and the exterior temperature is within the acceptable range determined by the user; it also includes the effects of cloud cover. The recommendations and cost saving predictions are then displayed to the user.

### 6.3.3 Code Example

This is a short example of a computer program encoding of the method of the invention could be coded. The example is not complete, but rather a general guideline. The code and its use will be understood by those having ordinary skill in the art. In this example, the functions name is “Main” and returns a null integer. After asking the user for their desired interior temperature, and making sure the user entered a valid temperature, the program goes into a switch statement that is based on the found character value of “season”; this value comes out of another function that implements a calendar application. Depending on the season, the program will suggest different options to the user.

```
/ main.c
// personalaudioshadesapp
//
// Created by Blake Van Thof on 8/26/13.
// Copyright (c) 2013. All rights reserved.
//
#include <stdio.h>
#include <math.h>
int Main(Void) {
    //declare variables
    double sun;
    char season;
    int outtemp;
    int dewpt;
    int inttemp;
    int cost;
    /*missing code: determine season from calender app*/
    /*missing code: determine outside data from weather app*/
    /*missing code: cost of using utilies function program*/
    //prompt user and assign variables
    printf(“What is your desired interior temperature?”);
    scanf(“%inttemp”,&inttemp);
    //if user enters anything besides a reasonable number, return an error
    if (inttemp<−100||inttemp>150) {
        printf(“Error: Please enter a valid temperature”);
        return 0;
    }
    //Switch statement for variable season
    switch(season){
case’spring’:
    if (outtemp>70)
        printf(“Open shades and windows”);
    else if (outtemp<70 && outtemp>55 && sun==’cloudy’)
        printf(“Close shades and windows”);
    else if (sun==’clear’)
        printf(“Open southeastern and southwestern facing windows”);
    break;
case ’summer’:
        if (outtemp<83 && dewpt<60)
        printf(“Close windows and shades”);
    else if (outtemp>83 && dewpt>60)
        printf(“Closing the windows and turning on the AC will
cost this much over the next 8 hrs: %d,&cost”);
    break;
case ’fall’:
    if (outtemp>70)
        printf(“Open shades and windows”);
    else if (outtemp<70 && outtemp>55 && sun==’cloudy’)
        printf(“Close shades and windows”);
    else if (sun=’clear’)
        printf(“Open southeastern and southwestern facing windows”);
    break;
case ’winter’:
    if (outtemp<50)
        printf(“Turning on the heat will cost this much over
the next 8 hrs: %d, &cost”);
    else if (sun==’clear’ || ’partycloudy’)
        printf(“close all shades besides ones that face southeast and
        southwest”);
    else if (sun==’cloudy’||’rain’||’sun’)
        printf(“Close all windows and shades, turning the heat on will
cost this much over the next 8 hrs: %d,&cost”);
    break;
    }
    return 0;
}
```

6.4 Abilities

### 6.4.1 Learning Feature

In one embodiment the software of the invention includes a learning feature. In more specific embodiments, the software of the invention includes default settings that would satisfy about eighty percent of users, but the software is capable of being personalized or learning the user's preferences and adjusts the default values based on their daily actions or inputted preferences. For example, if a user adjusts his (or her) windows and air conditioning to keep it relatively warm in their home or office, the software will take that information and adjust the default based on those actions or settings to create a warmer climate suggestion for the user. In another example, the software changes its default settings to better accommodate a user's needs, thereby allowing the user to manually change the temperature and humidity level that they want.

In other embodiments, the software of the invention has the ability to learn a schedule, such as the user's schedule, and is able to turn on and set environmental parameters, such as a thermostat, according to that schedule, e.g., to allow a user to come home to a house with a comfortable temperature and relative humidity. Such embodiments have the advantage of allowing a user's settings to be implemented automatically if the user forgets to set them, or to prevent a costly change in environmental settings if the user is absent.

In other embodiments, the outdoor conditions are compared to the indoor conditions, e.g., by using sensors and other hardware configured to determined environmental conditions. More specifically, the invention can utilize a first set of sensors for the indoor environment, and a second set of sensors for the outdoor environment. By using information from the sensor(s), the invention learns how the interior climate depends upon such factors as temperature, dew point, shade, and window direction, among others. In more specific embodiments, the invention has the ability to make predictions of local interior environmental conditions and the ability to record such predictions and sensor data in live time. By comparing predictions to live data, the invention has the ability to continuously learn how to more accurately make its predictions.

In still other embodiments, the invention includes using sensors to compare data from the windows in the location, either individually, in subgroups, or as a group, to determine the differences (if any) among or between windows. For example, if two different windows face the same direction, and both have their shades open, both windows should have approximate the same temperature. But if the same windows have a large difference in temperature (e.g., 10°), then there may be something wrong with the window (e.g, the window may be broken or accidentally left open or closed), and the invention can alert the user to check the window. Additionally, such a window comparator can record the effect of closing the window's shade on the relevant environment. For example if the shade is closed, and it has an effect on temperature in comparison to the window with the non-closed shade that is facing the same direction, then the shade may provide an unrecognized insulating factor; the invention may then suggest that the user closes the shade at night in order to keep the home warm during a cold night while using the HVAC unit to heat the home.

In yet other embodiment, the user can control the activity and passivity of the alerts provided by the invention to avoid annoying or unhelpful messages and warnings. For example, the invention can alert the user that a window is open and suggest that they close the window when an undesired temperature or rain is predicted. If the user would like this specific window to be open more often than not, then the user could set a parameter; so that when this window is open it does not send an alert to the user to shut the window, thereby preventing useless or annoying messages to the user. In still other embodiments, the alerting aspect of the invention has the ability to be customized by the user to define specific messages. Referring to the same example of a window that the user would like to keep open, if the user would like to keep the window open most of the time and shut this window only when there is a threat of rain, the user can configure the alerting system to sound only when there is a threat of rain on the way.

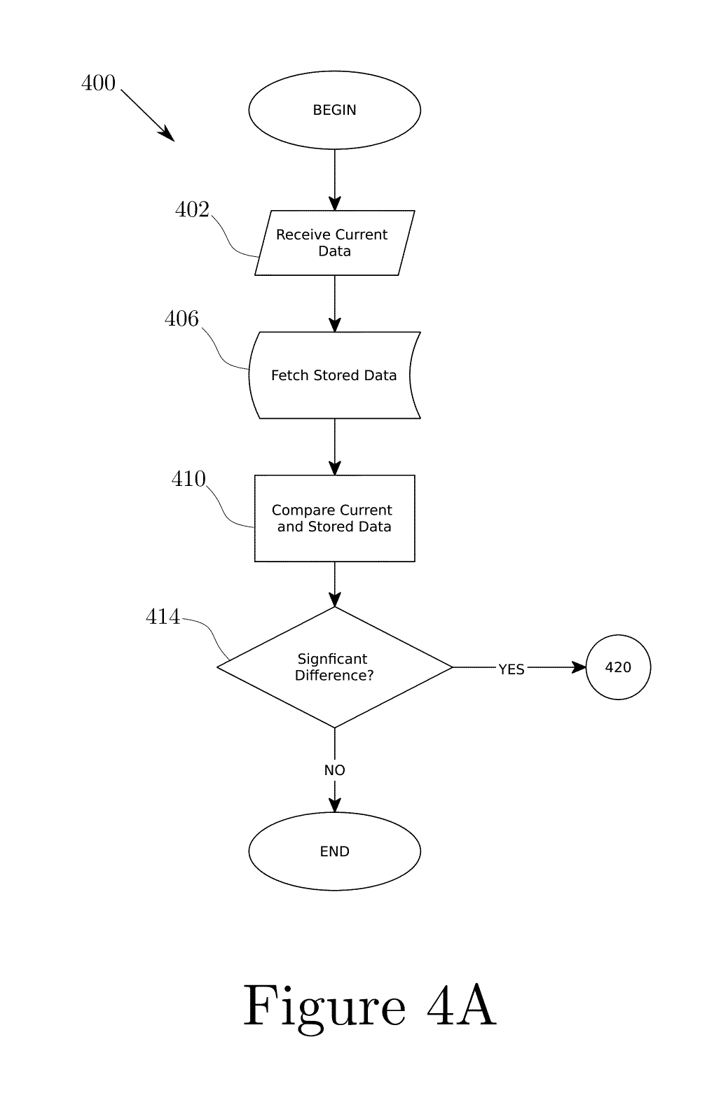

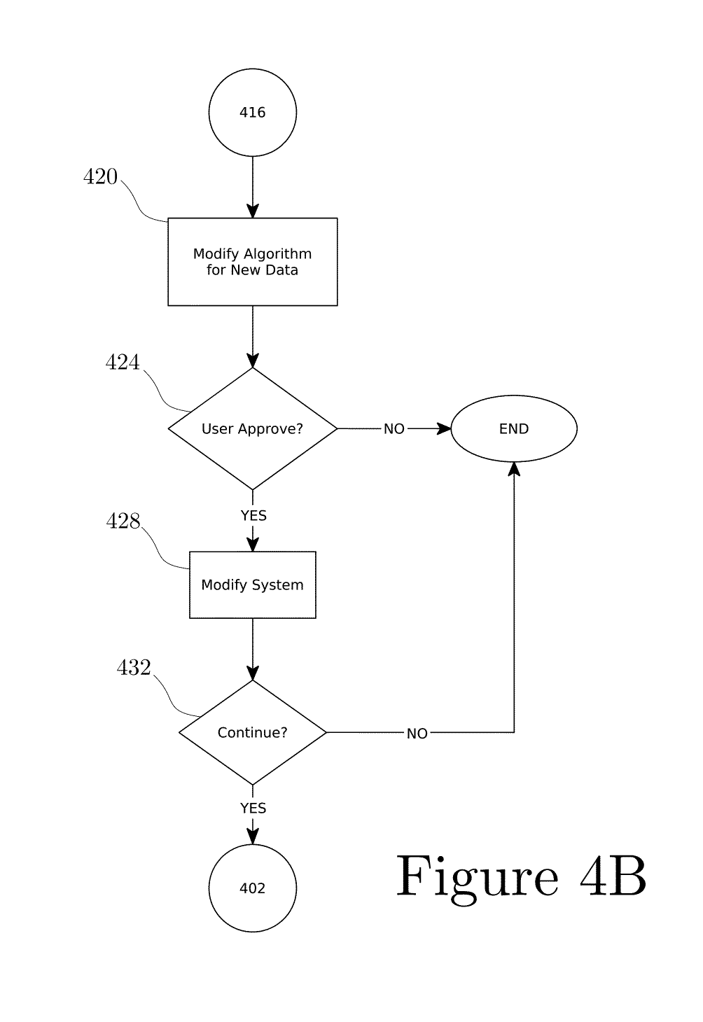

One example of the implementation of such a learning feature, using, electronically encoded instructions and data to be executed on an electronic computer processor using electronic memory, is shown in FIGS. 4A and 4B. Starting at 400 in FIG. 4A, current data about the user's location is fetched (402). The data includes those factors described herein as well as other relevant factors that will be familiar to those having ordinary skill in the art. Data retrieval includes retrieval from local memory, such as in response to interrogation of local external sensors (e.g., window light and temperature sensors) and from device sensors (e.g., thermometers, accelerometers, GPS, and compass information), data from user inputs to queries, and data from remote network sources such as those mentioned above. Stored, historical data from past analyses is also retrieved (406) and compared with the current data (408). If there is no significant difference (i.e., any difference(s) in the data are below one or more threshold values relevant to the comparison), then the process ends. Otherwise, the process continues.

Referring to FIG. 4B, if the difference is significant, then the algorithm is modified in accordance with the new data (420). In some embodiments, the user is queried for approval of the modification (422). If the user rejects modification, then the process ends. If the use accepts modification, then the system if modified (424). The process then determines whether to continue (e.g., by user query or data analysis). If the determination is negative, then the process terminates; otherwise, the flow control returns to the initial data retrieval (402).

The forgoing operations can be implemented by those having ordinary skill in the art, who will also understand the various types of data, communications, and values that are relevant to the implementation of those operations.

### 6.4.2 Identifying Daily User Patterns

In some embodiments, the invention begins recordings of daily data (see FIG. 2) and feeds those recordings to a learning module. The learning module accesses the data memory and looks at temperature and other relevant data recorded recently to determine patterns and trends; in the latter case, the data is also stored in memory for use in subsequent computations. For example if a specific action like consistent home temperature setting happens four days in a row or a week, the software will adjust its parameters and conditions accordingly.

### 6.4.3 Climate Conditions

In some embodiments, the user is prompted to see if preemptive home climate control is acceptable. (If new patterns emerge then these steps are recycled accordingly.) If the user answers “yes”, then the heat or air conditioning will be turned on and off by the invention; if a significant climate change occurs, such as a 10 degree rise in temperature, for example, then the user will be prompted whether they would like to continue the invention control. If not, the invention will start looking for a new pattern and start the process described above again.

### 6.4.4 Comfort Index

In still other embodiments, a “comfort index” is used to help determining recommendations for a user. Such a comfort can be determined using known methods, and can include, but is not limited to: temperature, probability of precipitation, humidity, wind speed, and cloud cover.

6.5 Window and Door Sensors

In those embodiments described above in which the invention warns the user if they have left a window or door open, the sensor can be one of those available commercially (e.g., from Aeon Labs of California), or the sensor can be designed specifically for use with the invention. Regarding commercially available sensors, it will be appreciated that many of the existing products are designed for security systems; thus, they can determine that a window is open or closed and set off an alarm when the security system is armed and the window is opened. Such a sensor does not achieve all the functionality capable of use with the invention. For example, more useful sensors would likely be mounted between the window and the shade to determine whether the shade is open or closed, and also whether the window is open or closed as well. An even more capable sensor could also detect light falling on the window using a light sensor as well as sensors for temperature and dew point.

A more specific embodiment for such sensors is one in which the sensor can be placed or mounted at the base of the window sill between the window and the shade when the shade is closed. Another logical mounting point for this device would be at the junction between the top window and the bottom window. In this location, the sensor would mounted on top of the frame of the bottom window around the same location that window locks are typically mounted. In other such embodiments, the sensors are mounted outside to determine the outside temperature, dew point and even possibly wind speed and direction. In still other embodiments, the sensors are built into the original construction of a window (e.g., in the window frame).

In one embodiment of such a device, the device includes two sensors that have the ability to determine whether the window and the shade are opened or closed (one sensor for each); these two sensors could be a variety of different types: ultrasonic, laser, magnetic, accelerometers, etc. in any case their main functionality is to determine when the window and/or shade is opened or closed. In another embodiment, among the sensors to determine window and shade location, there is a sensor for determining sunlight that is entering the window or lack thereof, and a sensor for temperature and dew point. For example and not limitation, the light sensor is a phone camera that could determine light input to estimate sunlight exposure. In another non-limiting example, the light sensor determines the amount of light that is getting into the window at any specific point in time. Light can be measured in many ways using LDRs (Light Dependent Resistors) or photodiodes, or photovoltaic cells (the latter enable both device power and monitoring simultaneously).

In some embodiments, temperature, humidity, or both, is monitored using various methods and sensors available in the market today. Temperature and humidity sensors are often coupled into one device.

In some embodiments, sensor data (e.g., temperature, dew point, sunlight, window and shade status) is transmitted to the device of the invention by Bluetooth signal. Still other embodiments include sensors like IR, ultrasound, sonar anemometers, and lasers, to more accurately determine energy savings, for example by adding a device to determine wind speed and direction a more accurate understanding of the energy savings or losses dependent upon actions taken or neglected to save energy can be determined.

The location of sensors may vary dependent upon the sensor that is being used. For example, if an accelerometer is used to determine if a window or shade is opened, then the sensor would be mounted on the window or shade that it is monitoring. However, if an ultrasonic sensor is being used to determine location of a window or shade, then the device would likely be mounted at the base of the window between the shade and the window. Some embodiments include three monitoring devices, either as three separate devices mounted in different locations or all contained in a single unit.

### 7 EXAMPLES

In areas where the winters, or the weather in general, is mild and only moderately cold the invention can tell the user to leave the heat off all day and keep the windows open as the user goes to work. For instance the morning temperature may be 50° although in the afternoon it will be 70° with a lower than 20% of rain. In this case, the savings could be accomplished by opening the window and turning the heat off before the user leaves for work; this would allow outdoor air to circulate through the house heating the home. When arriving home it will be within an acceptable temperature. As nighttime approaches the temperature will start to decrease and the app will be able to tell the user the optimal time to shut windows taking thermal mass and thermal conduction into account helping the user to store the thermal energy inside of your home. The user did not have to heat during the daytime, thus saving money. Conversely, in the summer, the invention will remind the user to open the windows to cool their environment during night.

Applying the same conditions as in the previous example, except the predicted weather is 40° in the morning and 50° in the afternoon with a high UV index. The invention would then tell the user to open the shades and shut off the heat to allow for light to heat the home. While the user was away the indoor temperature would slowly rise approaching acceptable temperatures while the user is at work.

Summer weather offers many options for control the environment economically, as described hereinabove. However, the present invention offers still more recommendations and solutions to save energy and money. For example, closing the blinds during the day to block ultraviolet or infrared rays (or both) is not an obvious solution for most users, since certain blinds are better than others; often the lighter the blinds the better, as they will reflect the light back outward rather than absorb it and transfer it into the house. Thus, in some embodiments the invention provides advertisements based on the information about the house that the user inputs. For example, if the user had darker shades, the invention can display commercial information for opaque white shades and display the projected cost savings if the user were to buy them.

There are some days in spring or fall when the temperature outside is about 50°, but in the afternoon it will heat up to 75° and be sunny. During these days a person may be tempted to put on the heat, because they don't know if it will remain cold outside, when in fact the sun would heat up the house naturally. Under conditions like this the invention sends a message to leave the heat off, because the sun will heat the house naturally. Furthermore the invention can tell the user when the house is expected to be within the acceptable temperature range as described hereinabove.

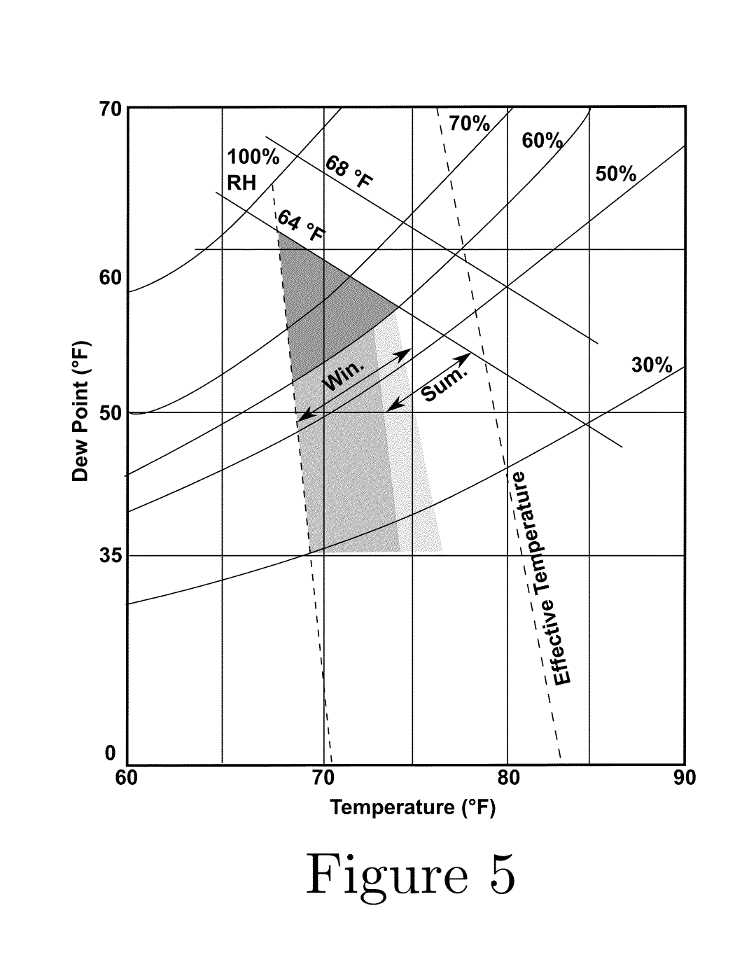

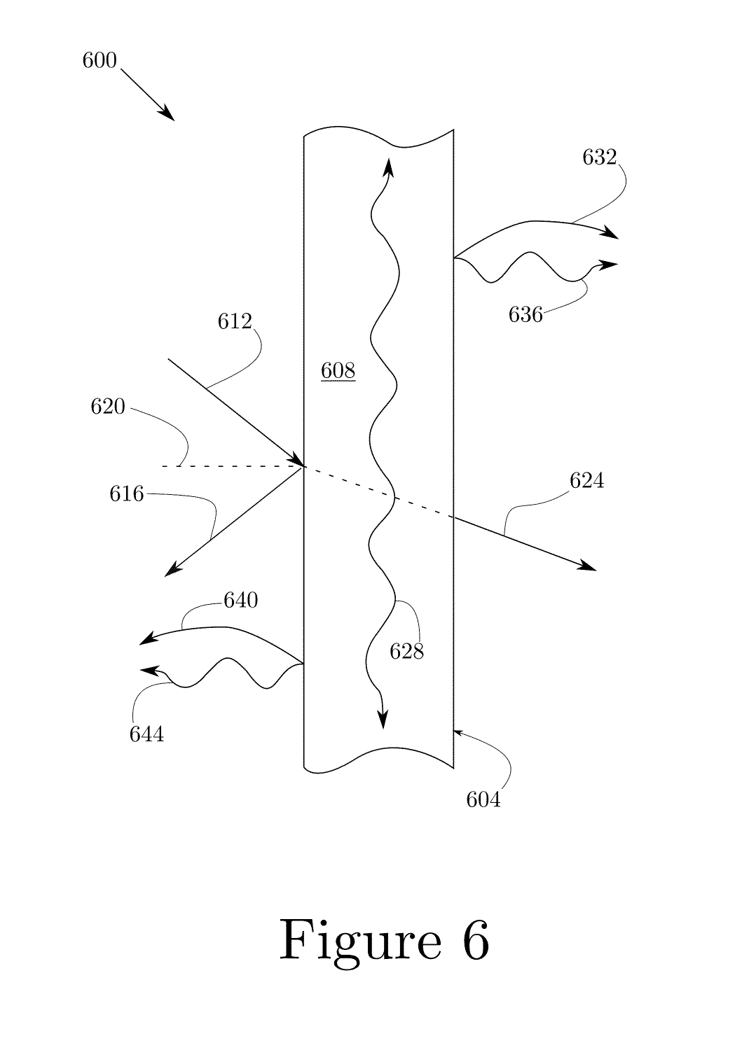

FIGS. 5 and 6 illustrate exemplary heuristic and physical models useful in the present invention. In some cases, the present invention does not produce direct calculation of particular quantities, but instead compares current parameters with established limitations for user comfort. For example and not limitation, FIG. 5 shows a chart based on ASHREA Standard 55-1992 (500) in which regions of user comfort (defined by the shaded areas) have been determined for various combinations of relative humidity, dew point, and temperature. In such embodiments, the invention compares current measured or derived values to determine if they fall within suitable ranges. Such methods reduce calculation burdens and can be implemented by those having ordinary skill in the art.

FIG. 6 illustrates a sun light transmission model useful in determining the light and heat provided to an indoor space from sun light impinging on a window (600). A window (604) having a heat-conductive interior (608) is hit by sunlight (612) which party reflects from the window surface (616) as shown by a normal (620). The light transmitted through the window is refracted in the window interior (624, dashed line) whereupon it emerges from the opposite surface (624, solid line). The light heats the interior of the window (628) and portions of heat and light are emitted to the interior (6332, 636) and exterior (640, 644). From such a model, direct calculation of internal environmental effects of sun light transmission can be performed using appropriate parameters familiar to those having ordinary skill in the art.

### 8 MACHINE IMPLEMENTATION

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on programmable systems including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semi conductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, can be received from and output to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to devices, systems or apparatus for performing the aforementioned operations. The system can be specially constructed for the required purposes, or it can be a general-purpose computer selectively activated or configured by a computer program stored in the computer. The processes presented above are not inherently related to any particular computer or other computing apparatus. In particular, various general-purpose computers can be used with programs written in accordance with the teachings herein, or, alternatively, it can be more convenient to construct a more specialized computer system to perform the required operations.

A number of implementations of the invention have been described. Nevertheless, it will be understood that various modifications can be made without departing from the spirit and scope of the invention. Accordingly, other embodiments are within the scope of the following claims.

### 9 CONCLUSION

Thus it will be seen that the present invention provides easy, reliable environmental analysis and recommendations for environmental control that enable users to save energy and money. Using the invention, users will better understand the factors governing their environment and will thereby better control their heating and cooling costs while maintaining comfort and utility.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. An electronic, computer-controlled system for determining an improved energy configuration for a structure and user of such structure, comprising:
at least one electronic memory storage device having at least a portion thereof dimensioned and configured to accept and store electronically encoded signals corresponding to at least one location parameter of said structure;
at least one electronic memory storage device having at least a portion thereof dimensioned and configured to accept and store electronically encoded signals corresponding to at least one construction parameter of said structure;
at least one electronic memory storage device having at least a portion thereof dimensioned and configured to accept and store electronically encoded signals corresponding to at least one atmospheric parameter of said structure; and
at least one electronic computer instruction processor configured to execute electronically encoded instructions to determine at least one recommendation for an improved energy configuration for said structure, said computer instructions processor being further configured retrieve said encoded signals corresponding to said at least one location parameter, said at least one construction parameters, and said at least one atmospheric parameter.

2. The system of claim 1, wherein said at least one location parameter includes the geographical coordinates of said structure.

3. The system of claim 2, wherein said at least one location parameter includes the compass facing of said structure.

4. The system of claim 1, wherein said at least one construction parameter includes at least one structure construction materials parameter.

5. The system of claim 1, wherein said at least one construction parameter includes at least one structure design parameter.

6. The system of claim 5, wherein said at one structure design parameter includes at least one parameter selected from the group consisting of: door location, door dimension, door type, window location, window dimension, and window type.

7. The system of claim 1, wherein said at least one atmospheric parameter includes at least one atmospheric parameter related to the exterior of said structure.

8. The system of claim 7, wherein said at least one atmospheric parameter related to the exterior of said structure includes at least one parameter related to current weather condition proximate to said structure, the climate of the location of said structure, historical weather, climate information related to the location of said structure, and combinations thereof.

9. The system of claim 7, wherein said at least one atmospheric parameter related to the exterior of said structure includes at least one parameter related to vegetation proximate to said structure.

10. The system of claim 1, wherein said at least one atmospheric parameter includes at least one atmospheric parameter related to the interior of said structure.

11. The system of claim 10, wherein said at least one atmospheric parameter related to the interior of said structure includes at least one parameter related to the internal temperature of said structure, the humidity of said structure, the comfort index of said structure, and combinations thereof.

12. A method for determining an improved energy configuration for a structure and user of such structure, comprising:
providing at least one electronic memory storage device having at least a portion thereof dimensioned and configured to accept and store electronically encoded signals corresponding to at least one location parameter of said structure;
providing at least one electronic memory storage device having at least a portion thereof dimensioned and configured to accept and store electronically encoded signals corresponding to at least one construction parameter of said structure;
providing at least one electronic memory storage device having at least a portion thereof dimensioned and configured to accept and store electronically encoded signals corresponding to at least one atmospheric parameter of said structure;
providing at least one electronic computer instruction processor configured to execute electronically encoded instructions to determine at least one recommendation for an improved energy configuration for said structure, said computer instructions processor being further configured retrieve said encoded signals corresponding to said at least one location parameter, said at least one construction parameters, and said at least one atmospheric parameter; and
executing said electronically encoded instructions using said at least one electronic computer instruction processor.

13. The method of claim 12, wherein said at least one location parameter includes the geographical coordinates of said structure.

14. The method of claim 12, wherein said at least one construction parameter includes at least one structure construction materials parameter.

15. The method of claim 12, wherein said at least one construction parameter includes at least one structure design parameter.

16. The method of claim 12, wherein said at least one atmospheric parameter includes at least one atmospheric parameter related to the exterior of said structure.

17. The method of claim 12, wherein said at least one atmospheric parameter includes at least one atmospheric parameter related to the interior of said structure.

18. The method of claim 12, further including providing a recommendation for an improved energy configuration for said structure to said user.

19. The method of claim 18, further including providing at least one electronic memory storage device having at least a portion thereof dimensioned and configured to accept and store electronically encoded signals corresponding to at least one user action in response to said recommendation.

20. The method of claim 19, further including providing electronically encoded instructions to said at least one electronic computer instruction processor for determining patterns and trends of said user's responses to said recommendations and said user's actions to control the interior environment of said structure.
